(19) United States
(12) Patent Application Publication
(10) Pub. No.: US 2024/0062589 A1
(43) Pub. Date: Feb. 22, 2024

(54) CLOUD-BASED PROCESSING OF LOGGED VEHICLE DATA

(71) Applicant: TUSIMPLE, INC., San Diego, CA (US)

(72) Inventors: Jinghui SONG, Tucson, AZ (US); Yijing LI, Tucson, AZ (US); Mohamed Hassan Ahmed Hassan Wahba, Tucson, AZ (US); Haimo BI, Tucson, AZ (US); Yu-Ju HSU, Tucson, AZ (US); Xiaoling HAN, San Diego, CA (US)

(21) Appl. No.: 18/450,034

(22) Filed: Aug. 15, 2023

Related U.S. Application Data
(60) Provisional application No. 63/371,630, filed on Aug. 16, 2022.

(51) Int. Cl. G07C 5/00; G07C 5/06

(52) U.S. Cl. CPC G07C 5/008; G07C 5/06

(57) ABSTRACT

A vehicle data processing system receives a set of data logged, during operation of each of a fleet of vehicles, by a data logger communicatively coupled to a controller area network (CAN) bus in each of the vehicles. The set of logged data can include a plurality of measurements generated by a sensor configured to transmit the measurements across the CAN bus, and can be received from a storage device to which the set of logged data was uploaded after the vehicle completed one or more trips. The system processes the logged data using a set of alerting rules. When a criterion in the set of alerting rules is satisfied by the set of logged data, the system outputs an alert.

### CROSS-REFERENCE TO RELATED APPLICATIONS

This patent application claims priority to and the benefit of U.S. Provisional Application No. 63/371,630, filed on Aug. 16, 2022. The aforementioned application of which is incorporated herein by reference in its entirety.

### BACKGROUND

Automotive vehicles have a wide variety of sensor hardware available and are continuously adding new capabilities as technology improves and costs reduce. As vehicles operate, these sensors and other components of the vehicle transmit data across a controller area network (CAN) bus. Various systems within the vehicle can use the data transmitted across the CAN bus in order to control operations of the vehicle.

### BRIEF DESCRIPTION OF THE DRAWINGS

FIG. 1 illustrates a block diagram of an example vehicle ecosystem of an autonomous vehicle.

FIG. 2 is a block diagram illustrating an environment in which a vehicle data processing platform operates, according to some implementations.

FIG. 3 illustrates an example dashboard that can be generated by the vehicle data processing platform.

FIGS. 4A-4B illustrate example plots that can be generated based on raw vehicle data.

FIG. 5 is a flowchart illustrating a process for offline processing of vehicle data, according to some implementations.

FIG. 6 is a flowchart illustrating another process for offline processing of vehicle data, according to some implementations.

FIG. 7 is a flowchart illustrating a process for detecting minimum risk condition (MRC) trajectory faults in an autonomous vehicle, according to some implementations.

FIG. 8 is a block diagram that illustrates an example of a computer system in which at least some operations described herein can be implemented.

### DETAILED DESCRIPTION

A vehicle data processing platform facilitates analysis of raw data logs that are captured during operation of a vehicle and subsequently uploaded to a cloud server. In some implementations, a vehicle data processing system a communications interface coupled to each of a plurality of vehicles, one or more processors coupled to the communications interface, and a non-transitory computer readable storage medium storing instructions, execution of which by the one or more processors causes the one or more processors to receive, from each of the plurality of vehicles, a set of logged data captured during operation of a corresponding vehicle by a data logger communicatively coupled to a controller area network (CAN) bus in the corresponding vehicle. In this implementation, each set of logged data includes a plurality of measurements generated by one or more sensors, wherein the one or more sensors are configured to transmit the plurality of measurements across the CAN bus, and wherein each set of logged data is received from a storage device to which the set of logged data was uploaded after the corresponding vehicle completed one or more trips. Execution of the instructions by the one or more processors further causes the one or more processors to filter, based on a type of vehicle, sets of logged data to generate filtered sets of logged data, process the filtered sets of logged data using a set of alerting rules configured based on the type of vehicle, and transmit, to a first vehicle using the communications interface, an alert when a criterion in the set of alerting rules is satisfied by the set of logged data from the first vehicle.

In some implementations, a non-transitory computer readable storage medium stores executable instructions, execution of which by one or more processors causes the one or more processors to receive, from each of a plurality of vehicles, a set of logged data captured during operation of a corresponding vehicle by a data logger communicatively coupled to a controller area network (CAN) bus in the corresponding vehicle, the set of logged data including a plurality of measurements generated by a sensor configured to transmit the plurality of measurements across the CAN bus, wherein the set of logged data is received from a storage device to which the set of logged data was uploaded after the corresponding vehicle completed one or more trips, perform, based on sets of logged data from the plurality of vehicles, at least a cross-sectional analysis or a longitudinal analysis for a subset of vehicles of the plurality of vehicles, wherein each of the subset of vehicles is of a common type, automatically generate, based on the cross-sectional analysis or the longitudinal analysis, a post-trip report to summarize operation of the corresponding vehicle during the one or more trips compared to at least another vehicle, and transmit, to the corresponding vehicle, the post-trip report.

In some implementations, a method for detecting minimum risk condition (MRC) trajectory faults in an autonomous vehicle based on logged CAN data comprises receiving, by a vehicle data processing system from a controller area network (CAN) bus in each of a plurality of autonomous vehicles, a set of logged data that was captured during operation of a corresponding autonomous vehicle, the set of logged data including a plurality of frames of vehicle trajectory data of the corresponding autonomous vehicle that are measured by one or more sensors in the corresponding autonomous vehicle, identifying, by the vehicle data processing system, based on the plurality of frames of vehicle trajectory data, one or more frames in which the corresponding autonomous vehicle operated in an MRC mode, and generate, by the vehicle data processing system, an alert when the corresponding autonomous vehicle is determined to have operated in the MRC mode in at least a specified number of consecutive frames of the vehicle trajectory data.

### I. Example Ecosystem of an Autonomous Vehicle

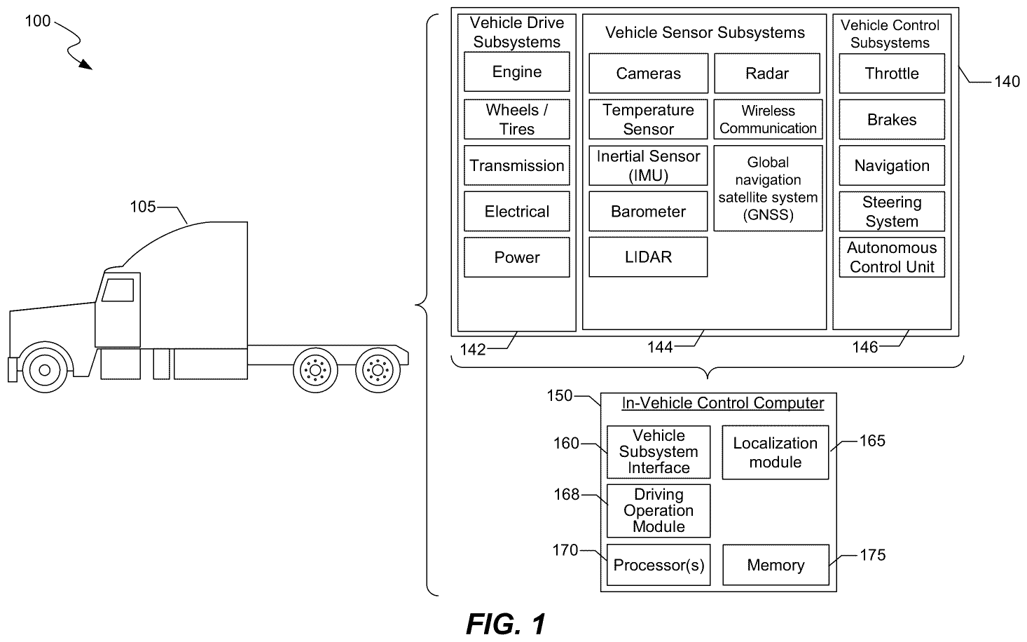

FIG. 1 illustrates a block diagram of an example vehicle ecosystem of an autonomous vehicle. The system 100 includes an autonomous vehicle 105, such as a tractor unit of a semi-trailer truck. The autonomous vehicle 105 may include a plurality of vehicle subsystems 140 and an in-vehicle control computer 150. The plurality of vehicle subsystems 140 can include, for example, vehicle drive subsystems 142, vehicle sensor subsystems 144, and vehicle control subsystems 146. FIG. 1 shows several devices or systems being associated with the autonomous vehicle 105. In some embodiments, additional devices or systems may be added to the autonomous vehicle 105, and in some embodiments, some of the devices or systems show in FIG. 1 may be removed from the autonomous vehicle 105.

An engine, wheels and tires, a transmission, an electrical subsystem, and a power subsystem may be included in the vehicle drive subsystems 142. The engine of the autonomous truck may be an internal combustion engine (or gas-powered engine), a fuel-cell powered electric engine, a battery powered electric engine/motor, a hybrid engine, or another type of engine capable of actuating the wheels on which the autonomous vehicle 105 (also referred to as vehicle 105 or truck 105) moves. The autonomous vehicle 105 can have multiple engines to drive its wheels. For example, the vehicle drive subsystems 142 can include two or more electrically driven motors. The transmission of the vehicle 105 may include a continuous variable transmission or a set number of gears that translate power created by the engine of the vehicle 105 into a force that drives the wheels of the vehicle 105. The vehicle drive subsystems 142 may include an electrical system that monitors and controls the distribution of electrical current to components within the vehicle drive subsystems 142 (and/or within the vehicle subsystems 140), including pumps, fans, and actuators. The power subsystem of the vehicle drive subsystems 142 may include components which regulate a power source of the vehicle 105.

Vehicle sensor subsystems 144 can include sensors which are used to support general operation of the autonomous truck 105. The sensors for general operation of the autonomous vehicle may include, for example, one or more cameras, a temperature sensor, an inertial sensor, a global navigation satellite system (GNSS) device (e.g., GNSS receiver), a barometer sensor, a LiDAR system, a radar system, and/or a wireless communications system. In some embodiments, GNSS may be used with or replaced with global navigation satellite system (GLONASS), a BeiDou Navigation System (BDS), a Quasi-Zenith Satellite System (QZSS), or an Indian Regional Navigation Satellite System (IRNSS).

The vehicle control subsystems 146 may include various elements, devices, or systems including, e.g., a throttle, a brake unit, a navigation unit, a steering system, and an autonomous control unit. The vehicle control subsystems 146 may be configured to control operation of the autonomous vehicle, or truck, 105 as a whole and operation of its various components. The throttle may be coupled to an accelerator pedal so that a position of the accelerator pedal can correspond to an amount of fuel or air that can enter the internal combustion engine. The accelerator pedal may include a position sensor that can sense a position of the accelerator pedal. The position sensor can output position values that indicate the positions of the accelerator pedal (e.g., indicating the amounts by which the accelerator pedal is depressed or that the accelerator pedal is undepressed). The brake unit can include any combination of mechanisms configured to decelerate the autonomous vehicle 105. The brake unit can use friction to slow the wheels of the vehicle in a standard manner. The brake unit may include an anti-lock brake system (ABS) that can prevent the brakes from locking up when the brakes are applied. The navigation unit may be any system configured to determine a driving path or route for the autonomous vehicle 105. The navigation unit may additionally be configured to update the driving path dynamically based on, e.g., traffic or road conditions, while, e.g., the autonomous vehicle 105 is in operation. In some embodiments, the navigation unit may be configured to incorporate data from a GNSS device and one or more predetermined maps so as to determine the driving path for the autonomous vehicle 105. The steering system may represent any combination of mechanisms that may be operable to adjust the heading of the autonomous vehicle 105 in an autonomous mode or in a driver-controlled mode of the vehicle operation.

The autonomous control unit may include a control system (e.g., a computer or controller comprising a processor) configured to identify, evaluate, and avoid or otherwise negotiate potential obstacles in the environment of the autonomous vehicle 105. In general, the autonomous control unit may be configured to control the autonomous vehicle 105 for operation without a driver or to provide driver assistance in controlling the autonomous vehicle 105. In some example embodiments, the autonomous control unit may be configured to incorporate data from the GNSS device, the radar, the LiDAR, the cameras, and/or other vehicle sensors and subsystems to determine the driving path or trajectory for the autonomous vehicle 105.

An in-vehicle control computer 150, which may be referred to as a vehicle control unit or VCU, can include, for example, any one or more of: a vehicle subsystem interface 160, a localization module 165, a driving operation module 168, one or more processors 170, and/or a memory 175. This in-vehicle control computer 150 may control many, if not all, of the operations of the autonomous truck 105 in response to information from the various vehicle subsystems 140. The memory 175 may contain processing instructions (e.g., program logic) executable by the processor(s) 170 to perform various methods and/or functions of the autonomous vehicle 105, including those described in this patent document. For instance, the data processor 170 executes the operations associated with vehicle subsystem interface 160 and/or localization module 165. The in-vehicle control computer 150 can control one or more elements, devices, or systems in the vehicle drive subsystems 142, vehicle sensor subsystems 144, and/or vehicle control subsystems 146. For example, the localization module 165 in the in-vehicle control computer 150 may determine the location of the autonomous vehicle 105 and/or a direction (or trajectory) in which the autonomous vehicle 105 should operate to enable the autonomous vehicle 105 to be driven in an autonomous mode.

The memory 175 may include instructions to transmit data to, receive data from, interact with, or control one or more of the vehicle drive subsystems 142, vehicle sensor subsystems 144, or vehicle control subsystems 146. The in-vehicle control computer (VCU) 150 may control the operation of the autonomous vehicle 105 based on inputs received by the VCU from various vehicle subsystems (e.g., the vehicle drive subsystems 142, the vehicle sensor subsystems 144, and the vehicle control subsystems 146). The VCU 150 may, for example, send information (e.g., commands, instructions or data) to the vehicle control subsystems 146 to direct or control functions, operations or behavior of the autonomous vehicle 105 including, e.g., its trajectory, velocity, and signaling behaviors. The vehicle control subsystems 146 may receive a course of action to be taken from one or more modules of the VCU 150 and may, in turn, relay instructions to other subsystems to execute the course of action.

### II. Examples of a Cloud-Based Vehicle Data Processing Platform

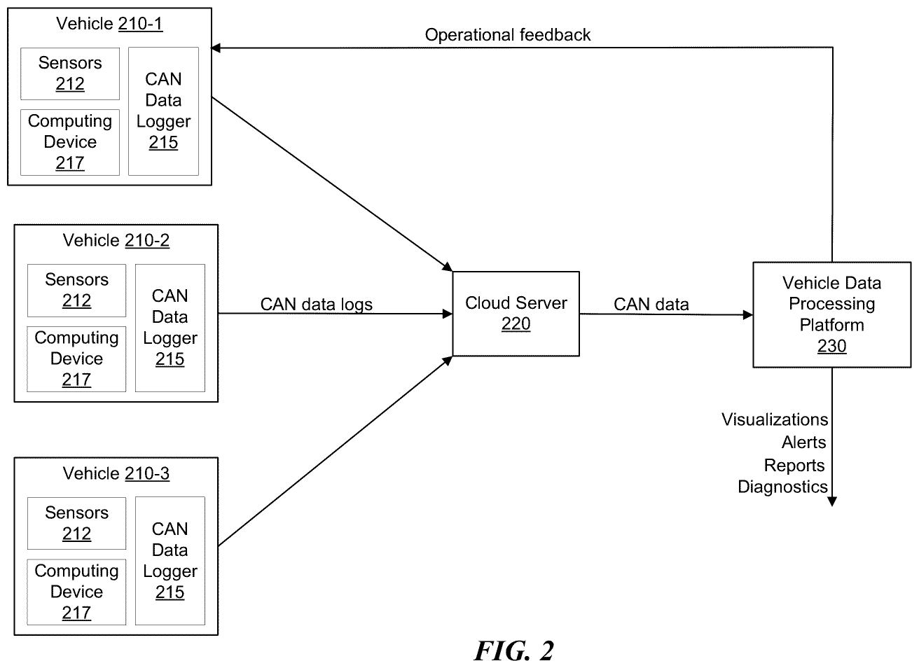

FIG. 2 is a block diagram illustrating an environment 200 in which a vehicle data processing platform 230 operates. As shown in FIG. 2, the environment can include one or more vehicles 210-x for x=1, 2 and 3, a cloud server 220, and the vehicle data processing platform 230. In some embodiments, the vehicle data processing platform 230 is a cloud-based implementation that is communicatively coupled to the cloud server 220. In other embodiments, the cloud server 220 and the vehicle data processing platform 230 are implemented in a cloud-based software-as-a-service (SaaS) and/or a cloud-based platform-as-a-service (PaaS). Other implementations of the environment 200 can include additional, fewer, or different components, and functionality can be distributed differently between the components.

The vehicle 210-x can include any vehicle capable of carrying one or more passengers, including any type of land-based automotive vehicle (such as cars, trucks, or buses), train, flying vehicle (such as airplanes, helicopters, or space shuttles), or aquatic vehicle (such as cruise ships). In some implementations, the vehicle 210-x is similar to the autonomous vehicle 105 described with respect to FIG. 1. However, the vehicle 210-x can be a vehicle operated by any driving mode, including fully manual (human-operated) vehicles, self-driving vehicles, or hybrid-mode vehicles that can switch between manual and self-driving modes. As used herein, an autonomous driving mode is a mode in which the vehicle 210-x operates at least one driving function in response to real-time feedback of conditions external to the vehicle 210-x and measured automatically by the vehicle 210-x. The driving functions can include any aspects related to control and operation of the vehicle, such as speed control, direction control, or lane positioning of the vehicle 210-x. To control the driving functions, the vehicle 210-x can receive real-time feedback from external sensors associated with the vehicle 210-x, such as sensors capturing image data of an environment around the vehicle 210-x, or sources outside the vehicle 210-x, such as another vehicle or the remote server 220. The vehicle 210-x can process the sensor data to, for example, identify positions and/or speeds of other vehicles proximate to the vehicle 210-x, track lane markers, identify non-vehicular entities on the road such as pedestrians or road obstructions, or interpret street signs or lights. In some cases, the vehicle 210-x operates in an autonomous mode under some driving circumstances, such that the driver does not need to control any driving functions during the autonomous operation. In other cases, the vehicle 210-x controls one or more driving functions while the driver concurrently controls one or more other driving functions.

The vehicle 210-x can include a plurality of sensors 212 configured to generate data related to parameters inside the vehicle 210-x and outside the vehicle 210-x. Example parameters that can be measured by the sensors 212 include vehicle speed, acceleration, lane position, steering angle, fuel level, engine oil pressure, in-cabin decibel level, audio volume level, current information displayed by a multimedia interface (e.g., a user interface or a communications interface) in the vehicle, force applied by the user to the multimedia interface, ambient light, humidity level, raw video feed (whether from sources internal or external to the vehicle), audio input, user metadata, user state, calendar data, user observational data, contextual external data, traffic conditions, weather conditions, in-cabin occupancy information, road conditions, user drive style, or non-contact biofeedback. Thus, example sensors 212 include internal or external cameras, eye tracking sensors, temperature sensors, audio sensors, accelerometers, gyroscopes, light detecting and ranging (LIDAR) sensors, global positioning sensors, infrared sensors, oxygen monitors, fuel gauge sensors, engine oil pressure sensors. In some examples, the multimedia interface includes a touch screen that combines both an input (“touch panel”) and output (“display”) device. The touch panel may be configured to provide and/or accept multi-touch gestures and support for hyperlinks (or links).

Each vehicle 210-x includes a data logger 215. As the vehicle 210-x is operated, the data logger 215 captures data transmitted over a controller area network (CAN) bus and stores the data in a log. In general, the CAN bus is used to transmit information between components of the vehicle to facilitate aspects of vehicle operation and control. For example, the CAN bus transports signals generated by some or all of the sensors 212 in the vehicle and/or signals generated or used by control systems of the vehicles (such as engine control, anti-lock brake systems, parking assist systems, or cruise control systems). Implementations of the data logger 215 capture all data streams on the CAN bus or specified data streams, recording the captured data into a non-volatile memory such that the data can be later retrieved from the vehicle 210-x and analyzed to discover events, diagnose errors, compare operation of different vehicles, compare operation of the same vehicle at different times, or to extract other valuable insights from the logged data.

Each vehicle 210-x can further include a computing device 217 that is configured to retrieve data logs generated by the data logger 215 and upload the logs to the cloud server 220. The computing device 217 can include programmable circuitry (e.g., one or more microprocessors), special-purpose hardwired (i.e., non-programmable) circuitry, or a combination or general- and special-purpose hardware. Special-purpose circuitry can be in the form of, for example, one or more application-specific integrated circuits (ASICs), programmable logic devices (PLDs), field-programmable gate arrays (FPGAs), etc.

The computing device 217 can upload the data logs to the cloud server 220 after a trip, where a trip includes, for example, a period of vehicle operation between an origin location and a destination location. For example, the data logs can be uploaded whenever the vehicle 210-x completes a trip, after a specified number of trips, or at a set time each day or each week regardless of the number of trips that occurred in the period. In some implementations, the computing device 217 executes instructions that cause the computing device 217 to automatically upload the data logs at specified times. Some implementations of the computing device 217 alternatively upload the data logs during a trip. For example, the computing device 217 may upload data logs during a longer trip, such as when a cellular or Wi-Fi signal of a sufficient strength has been detected.

In some embodiments, the computing device 217 uploads the data logs to the cloud server 220 using Public Key Infrastructure (PKI) encryption, which is a type of cryptology that can be used to securely transmit data through data encryption, device authentication, and other security features. PKI encryption uses certificates to identify and verify communicating devices to securely transmit data and prevent spoofing, wire tampering, and uncertified devices from connecting. The National Highway and Traffic Safety Administration (NHTSA) currently recommends PKI encryption as a voluntary best practice for automakers based on the data logs containing personally identified information (PII), which includes GPS location, onboard diagnostics, and smartphone synchronizations.

The cloud server 220 maintains a store of data captured by the data logger 215. The CAN data captured by the data logger can be stored in a repository at the cloud server 220 in association with identifiers such as an identifier of the vehicle, date and time of the trip during which the data was captured, or a unique trip identifier (which can be mapped to information such as start or end times for the trip, start or end location, vehicle identity, driver identity, or contents carried in the vehicle on the trip). In some implementations, the cloud server 220 performs preliminary processing steps on the raw CAN data to prepare it for analysis by the vehicle data processing platform 230. In an example, the cloud server 220 can convert the data into a file type that is readable by the vehicle data processing platform 230, perform data normalization, apply time stamps or vehicle identifiers to raw data entries, or the like. In another example of preliminary processing, the cloud server can detect an event of interest in one or more of the logged data streams, and then concatenate all the logged data streams to focus on the time period surrounding the event of interest.

The cloud server 220 and computing device 217 can communicate over one or more network channels, which can include any of a variety of individual connections via the internet such as cellular or other wireless networks, such as 4G networks, 5G networks, or Wi-Fi. In some embodiments, the network may connect terminals, services, and mobile devices using direct connections such as radio-frequency identification (RFID), near-field communication (NFC), Bluetooth™, low-energy Bluetooth™ (BLE), Wi-Fi™, ZigBee™, ambient backscatter communications (ABC) protocols, USB, or LAN. Because the information transmitted may be personal or confidential, security concerns may dictate one or more of these types of connections be encrypted or otherwise secured. In some embodiments, however, the information being transmitted may be less personal, and therefore the network connections may be selected for convenience over security. The network may comprise any type of computer networking arrangement used to exchange data. For example, the network may be the Internet, a private data network, virtual private network using a public network, and/or other suitable connection(s) that enables components in system environment 200 to send and receive information between the components of system environment 200. The network may also include a public switched telephone network (“PSTN”) and/or a wireless network.

The vehicle data processing platform 230 interfaces with the cloud server 220 to facilitate user access to and interaction with the CAN data uploaded from the vehicle 210-x. As shown in FIG. 2, the cloud server 220 and the vehicle data processing platform 230 receive logged data from multiple vehicles. In various implementations, and optionally as configured by a user, the vehicle data processing platform 230 can generate visualizations, produce alerts, output data files with the vehicle data, facilitate querying of the vehicle data, or enable custom analysis of the data. In an example, the data from the multiple vehicles can be processed as part of a longitudinal analysis (e.g., comparisons over time) or a cross-sectional (or latitudinal) analysis (e.g., comparisons at a single point in time). This enables the vehicle data processing platform to identify issues in specific types of vehicles by comparing the logged data from all vehicles of that specific type.

Embodiments of the disclosed technology are advantageously configured to use the cloud-based vehicle data processing platform 230 to analyze logged data from tens of vehicles (if not more), thereby enabling it to determine whether the problem encountered by one or more vehicles is mechanical, algorithmic, or environmental, and issue an appropriate alert to those vehicles. For example, if logged data from a particular vehicle includes traction issues and the weather sensors are malfunctioning, one option would be to immediately trigger a minimum risk condition (MRC) trajectory fault. However, if other vehicles on the same route indicate that there is heavy rain in that area, then the traction issues in the logged data from the particular vehicle are to be expected, and an MRC trajectory fault need not be immediately triggered, especially if the sensors that work in concert with the algorithmic driving subsystem are functioning properly. In this example, collecting logged data from multiple vehicles enables vehicle data processing platform 230 to detect an environmental condition that exists, but is not adversely affecting the operation of a particular vehicle. For another example, and based on the logged data, vehicle data processing platform 230 can determine whether an alleged fault in a vehicle is either mechanical or algorithmic, and can issue different alerts based on the result. If the fault in mechanical, routing the vehicle to the nearest mechanic may be appropriate, but if the fault is algorithmic, then the vehicle should be routed to a full-fledged service center because debugging the logged data to determine how the algorithm should be improved may be warranted.

In some embodiments, the vehicle data processing platform 230 is configured to determine whether an alert should be issued for mechanical, algorithmic, or environmental issues is based, in part, on the functioning of the powertrain and braking subsystems (for a mechanical issue), deviations from a trajectory traveled by other vehicles (for an algorithmic issue), and external or operational facts (for an environmental issue, which may include inclement weather, construction on the route, detours, etc.)

In some embodiments, the vehicle data processing platform 230 generates a data file that contains a set of logged sensor measurements, such as the set of measurements collected over the course of a trip, a set of measurements collected from a portion of a trip (e.g., the portion of a trip during which an autonomous driving mode was activated), or a set of measurements collected over the course of multiple trips (e.g., all driving performed in a given day). The data file can be output in a format that is readily analyzed via a user's custom scripts or imported into a third party application (such as a spreadsheet application) for analysis of the logged data. Additionally, or alternatively, the data file can be formatted for use within a custom tool provided by the platform 230. A user can run queries against the data file to extract data of interest.

The vehicle data processing platform 230 can be configured to generate alerts based on data from multiple vehicles 210-x, according to some implementations. For an example, the vehicle data processing platform receives logged data that includes specific information from nearly all vehicles of a specific type (e.g., Toyota Corollas manufactured between 2010-2015), but not from at least one vehicle of this specific type. In this example, the vehicle data processing platform 230 is configured to generate an alert for the vehicles whose logged data did not include the specific information. That is, the lack of information from certain vehicles is used to trigger an alert by the vehicle data processing platform 230.

In some embodiments, the vehicle data processing platform 230 is configured to receive specific information from a strict subset of the multiple vehicles communicating with the vehicle data processing platform 230, e.g., in FIG. 2, only some vehicles (210-1, 210-2) send the specific information in their logged data, but at least one other vehicle (210-3) does not. Upon receiving the logged data from the three vehicles, the vehicle data processing platform 230 determines that the at least one other vehicle (210-3) is not operating in a manner similar to the other vehicles (210-1 and 210-2) because its logged data does not contain the specific information, and generates an alert for the at least one other vehicle (210-3). For example, if all three vehicles are operating autonomously along the same route that includes a steep incline, and the strict subset of vehicles (210-1 and 210-2) transmit logged data that includes a specific gear shifting pattern to traverse the include in a fuel-efficient manner, but the other vehicle (210-3) uses a different gear shifting pattern, the vehicle data processing platform 230 determines that the other vehicle (210-3) is not operating as intended, and issues an alert thereto.

The vehicle data processing platform 230 can enable a user to generate custom alerting rules. Each custom alerting rule specifies a criterion that, when satisfied, causes the platform to output an alert. The user can define alerting criteria with respect to any parameter in the platform, such as raw sensor data measurements, measurements generated by applying a computational or statistical operation to one or more sensor data measurements, or events generated based on an analysis of a set of sensor data measurements and/or other inputs. For example, a user can define an alerting criterion that causes an alert to be generated whenever a sensor measurement exceeds a specified threshold. Another example criterion causes an alert to be generated whenever a trip data log indicates a specified number of lost frames (e.g., because a sensor failed to generate data during the frames). Still another example criterion causes an alert to be generated whenever a particular type of event is detected, where the event is detected based on a combination of sensor measurements.

In some embodiments, the vehicle data processing platform 230 can additionally or alternatively maintain a set of preconfigured alerting rules, which can be enabled automatically or in response to a user request.

Alerting rules can be configured in the vehicle data processing platform 230 to facilitate offline diagnostics. A user can define an alerting rule to monitor any desired aspect for diagnostic purposes. Some alerting rules, for example, can facilitate diagnosis of low-level concerns, such as sensor calibration issues or sensor faults, by causing alerts to be generated when the outputs of specified sensors are inconsistent. Other alerting rules can facilitate diagnosis of higher-level vehicle operational parameters. In an example, an alerting rule is used to detect minimum risk condition (MRC) trajectory faults. When the vehicle is operating autonomously, it can switch into an MRC mode when a fault is detected in the automated driving system that renders the vehicle unable to perform a driving task with sufficient accuracy. In the MRC mode, the vehicle operates according to a predetermined safety procedure to reduce the risk of a crash as a result of the fault in the automated driving system. Such predetermined safety procedures can include, for example, stopping the vehicle. By analyzing the CAN data logs uploaded from a vehicle, the vehicle data processing platform 230 can detect frames in which the vehicle experienced a trajectory fault that caused the vehicle to operate under an MRC mode. An alerting rule can correspondingly cause the vehicle data processing platform 230 to generate an alert when the vehicle control output differed from the reference model output in a specified number of consecutive frames.

Alerts output by the vehicle processing platform 230 can take the form of an electronic message, such as an e-mail or text message, sent to an administrator. In some implementations, the electronic message is sent for individual items, such as individual sensor data measurements, that satisfy an alerting criterion. The electronic message can additionally or alternatively be formatted as a report summarizing a data set, where the summary indicates, for example, a number or percentage of a total number of sensor measurements that satisfied an alerting criterion. The alert can further be output as a graphical representation of data, such as a plot of raw sensor data or processed events, with those data points or events that satisfy an applicable alerting criterion having markings, highlights, or other annotations to indicate that they satisfied the rule. As an illustrative example, the graphical representation can be a time-series graph of measurements output by a particular type of sensor in the vehicle 210-x (based on the “operational feedback” from the vehicle data processing platform 230), where the sensor data measurements are color-coded based on whether each measurement satisfies an alerting criterion (e.g., red) or does not satisfy an alerting criterion (e.g., green).

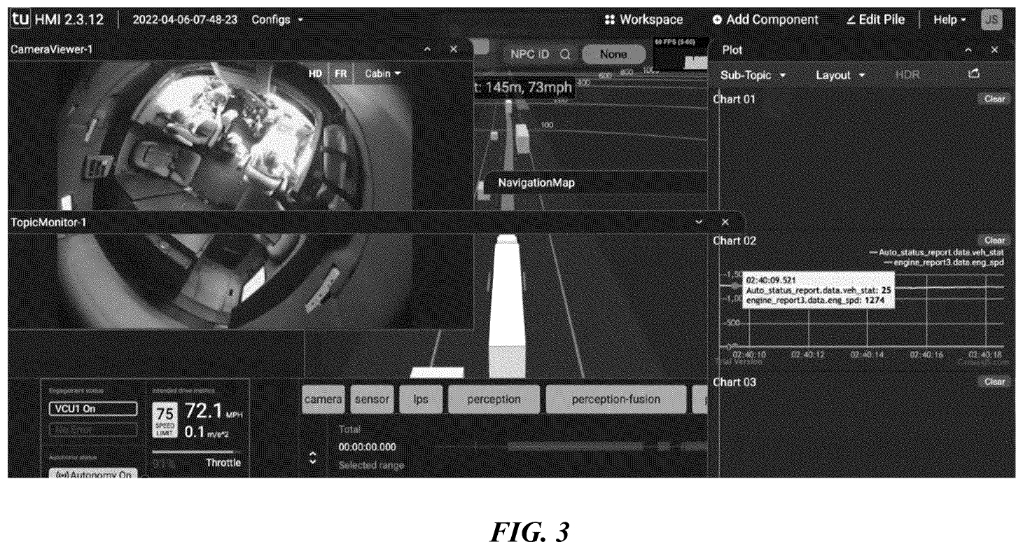

Some implementations of the vehicle data processing platform 230 generate dashboards to visualize aspects of the CAN data uploaded by a vehicle. FIG. 3 illustrates an example dashboard that can be generated by the vehicle data processing platform 230. The dashboard can be generated from stored vehicle data to reconstruct any portion of or an entirety of a trip. For example, the dashboard can illustrate a reconstruction of aspects a trip using corresponding sensor data. Such aspects can include, for example, a LIDAR map generated by the vehicle during at least a portion of the trip, a plot illustrating time-based sensor measurement, an internal or external video feed, a speed gauge showing a speed of the vehicle, etc. Using timestamps of the sensor data and/or other CAN data, the dashboard can “replay” some or all of a trip by sequentially outputting synchronized time-based representations of the data. The dashboard can include playback controls to, for example, enable a user to pause replay of the trip data, advance forward or backward through the time-based data, or speed up or slow down playback. Furthermore, items can be added to or removed from the dashboard as desired by the user.

In some implementations, alerts are generated and output via the dashboard during playback of the trip data. As the time-based sensor data is replayed, the dashboard can display pop-ups, for example, that identify events that were detected using the sensor data. The pop-ups can be synchronized with the sensor data playback such that the notification of an event is output at the same time relative to the sensor data as it occurred during the trip. Such events can include actions by the vehicle's driver (e.g., engaging self-driving mode, turning headlights on or off, or changing an audio input source), events detected in an environment of the vehicle (e.g., a pedestrian walking by the vehicle or another vehicle swerving into the vehicle's lane), or actions autonomously taken by the vehicle (e.g., driving at a speed that exceeds a specified threshold, or engaging in an evasive braking or swerving maneuver to avoid an accident).

Instead of, or in addition to, displaying time-based replays of trip data, the dashboard can display post-trip analytics that are generated based on the CAN data logs received from one or more vehicles or for one or more trips. For example, for a single trip, the dashboard can display analytics such as a graph of vehicle speed measured over the course of the trip, a count of evasive braking events, an estimate of fuel efficiency during the trip, a measurement of total distance traveled and duration of the trip, or other such parameters. In another example, a dashboard summarizing multiple trips (whether performed by the same vehicle or by different vehicles) can display analytics such as an average trip duration, a comparison of fuel economy between trips, a comparison of a number of MRC trajectory faults or conditions under which such faults occurred, or a comparison of other operational parameters either resulting during different trips by the same vehicle or during trips by different vehicles. Furthermore, such post-trip analytics can be output in a format other than displaying the analytics on the dashboard; e.g., the vehicle data processing platform 230 can generate an electronic message to summarize operation of a vehicle during one or more trips. Operational parameters included in the post-trip analytics can be selected by a user.

In some implementations, a link to generate the dashboard can be output in an alert. When the link is selected, the dashboard is populated with sensor data captured around a time corresponding to the alert. For example, if the alert relates to an event detected in the CAN data logs, the dashboard is populated with any sensor data from the CAN logs with time stamps corresponding to a specified amount of time before the event occurred (e.g., five seconds) through a specified amount of time after the event occurred (e.g., ten seconds). By synchronizing the data obtained from sensors around the time of the event, the dashboard can enable a user to review the holistic circumstances surrounding the event to understand the cause of the event, the vehicle's response to the event, the driver's response to the event, or the like.

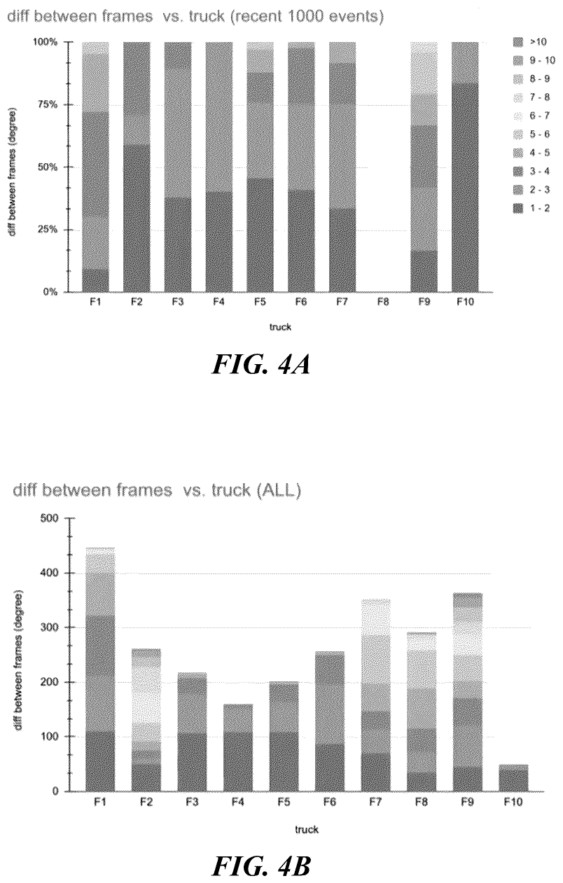

FIGS. 4A-4B illustrate example charts that can be generated based on the raw CAN data uploaded to the cloud server 220. The chart shown in FIG. 4A compares MRC trajectory data for ten trucks, where the plot illustrates, for each truck, a count of the last 2000 events in which the vehicle operated in an MRC mode. FIG. 4B is a chart illustrating similar data generated across all MRC trajectory events for the ten trucks of interest. In some implementations, the charts in FIGS. 4A-4B are presented via a dashboard generated by the vehicle data processing platform 230, where they can be automatically updated by the platform as new CAN data is uploaded from the trucks. The charts can instead be generated by the platform on demand by accessing applicable data logs from the trucks of interest, stored for example by the cloud server 220. In still another example, the charts are generated by a user interacting with a data analysis tool or spreadsheet application (such as MICROSOFT EXCEL), where the applicable data logs are imported into the tool or application via the vehicle data processing platform 230.

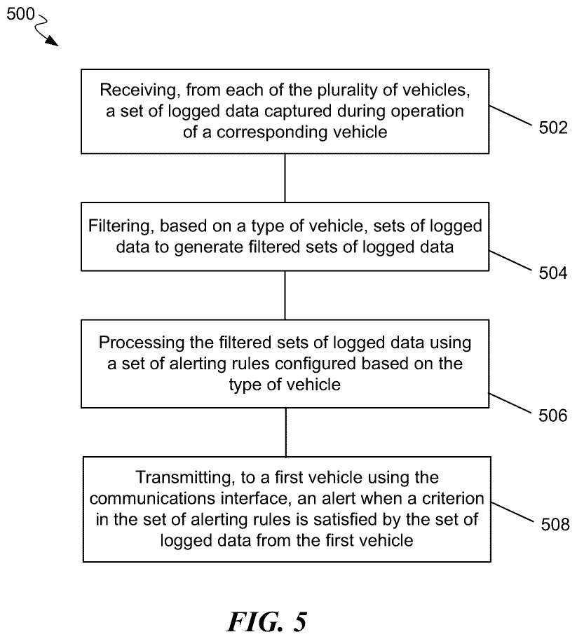

FIG. 5 is a flowchart illustrating a process 500 for offline processing of vehicle data, according to some implementations. The process 500 can be performed, for example, by the vehicle data processing platform 230.

The process 500 includes, at operation 502, receiving, from each of the plurality of vehicles, a set of logged data captured during operation of a corresponding vehicle. In this operation, the set of logged data is captured by a data logger communicatively coupled to a controller area network (CAN) bus in the corresponding vehicle, and each set of logged data includes a plurality of measurements generated by one or more sensors, the one or more sensors are configured to transmit the plurality of measurements across the CAN bus, and each set of logged data is received from a storage device to which the set of logged data was uploaded after the corresponding vehicle completed one or more trips.

The process 500 includes, at operation 504, filtering, based on a type of vehicle, sets of logged data to generate filtered sets of logged data.

The process 500 includes, at operation 506, processing the filtered sets of logged data using a set of alerting rules configured based on the type of vehicle.

The process 500 includes, at operation 508, transmitting, to a first vehicle using the communications interface, an alert when a criterion in the set of alerting rules is satisfied by the set of logged data from the first vehicle.

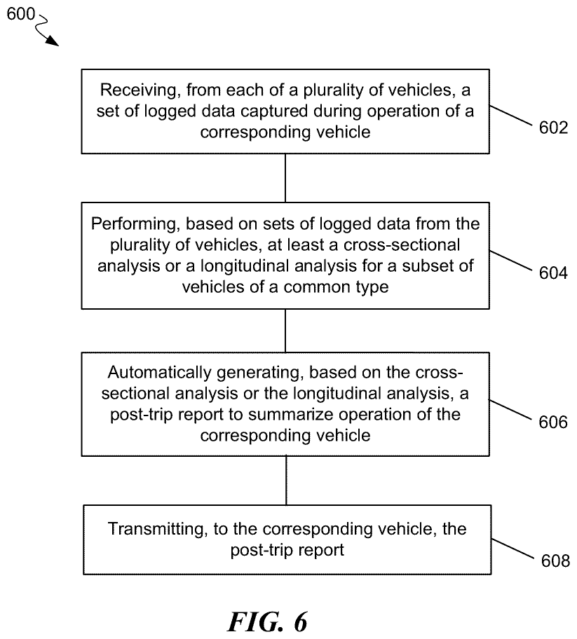

FIG. 6 is a flowchart illustrating another process 600 for offline processing of vehicle data, according to some implementations. Like the process 500, the process 600 can be performed by the vehicle data processing platform 230.

The process 600 includes, at operation 602, receiving, from each of a plurality of vehicles, a set of logged data captured during operation of a corresponding vehicle. In this operation, the set of logged data is captured by a data logger communicatively coupled to a controller area network (CAN) bus in the corresponding vehicle, and the set of logged data includes a plurality of measurements generated by a sensor configured to transmit the plurality of measurements across the CAN bus, and the set of logged data is received from a storage device to which the set of logged data was uploaded after the corresponding vehicle completed one or more trips. The receiving of data in operation 602 can be similar to the receiving at block 502, described above.

The process 600 includes, at operation 604, performing, based on sets of logged data from the plurality of vehicles, at least a cross-sectional analysis or a longitudinal analysis for a subset of vehicles of a common type.

The process 600 includes, at operation 606, automatically generating, based on the cross-sectional analysis or the longitudinal analysis, a post-trip report to summarize operation of the corresponding vehicle.

The process 600 includes, at operation 608, transmitting, to the corresponding vehicle, the post-trip report. The report can be output, for example, via a dashboard generated by the vehicle data processing platform 230, which may enable a user to interact with the post-trip report to filter data, perform additional calculations, generate comparisons between time periods within the same or different trips, etc.

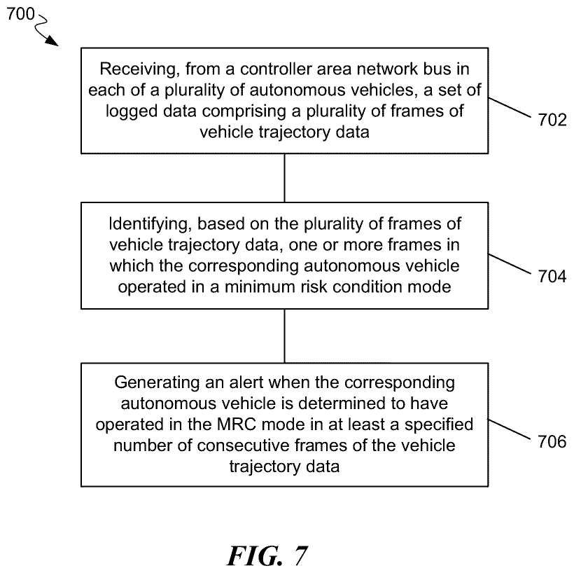

FIG. 7 is a flowchart illustrating a process 700 for detecting MRC trajectory faults in an autonomous vehicle. Like the processes 500 and 600, the process 700 can be performed by the vehicle data processing platform 230.

The process 700 includes, at operation 702, receiving, from a controller area network (CAN) bus in each of a plurality of autonomous vehicles, a set of logged data comprising a plurality of frames of vehicle trajectory data. In this operation, the set of logged data was captured during operation of a corresponding autonomous vehicle, and the plurality of frames of vehicle trajectory data of the corresponding autonomous vehicle were measured by one or more sensors in the corresponding autonomous vehicle.

The process 700 includes, at operation 704, identifying, based on the plurality of frames of vehicle trajectory data, one or more frames in which the corresponding autonomous vehicle operated in a minimum risk condition mode.

The process 700 includes, at operation 706, generating an alert when the corresponding autonomous vehicle is determined to have operated in the MRC mode in at least a specified number of consecutive frames of the vehicle trajectory data.

### III. Example Implementations of the Disclosed Technology

The described embodiments provide the following technical solutions:

A1. A cloud-based vehicle data processing system, comprising: a communications interface coupled to each of a plurality of vehicles; one or more processors coupled to the communications interface; and a non-transitory computer readable storage medium storing instructions, execution of which by the one or more processors causes the one or more processors to: receive, from each of the plurality of vehicles, a set of logged data captured during operation of a corresponding vehicle by a data logger communicatively coupled to a controller area network (CAN) bus in the corresponding vehicle, wherein each set of logged data includes a plurality of measurements generated by one or more sensors, wherein the one or more sensors are configured to transmit the plurality of measurements across the CAN bus, and wherein each set of logged data is received from a storage device to which the set of logged data was uploaded after the corresponding vehicle completed one or more trips; filter, based on a type of vehicle, sets of logged data to generate filtered sets of logged data; process the filtered sets of logged data using a set of alerting rules configured based on the type of vehicle; and transmit, to a first vehicle using the communications interface, an alert when a criterion in the set of alerting rules is satisfied by the set of logged data from the first vehicle.

A2. The cloud-based vehicle data processing system of solution A1, wherein the set of logged data includes a plurality of frames of vehicle trajectory data of the first vehicle, and wherein processing the set of logged data using the set of alerting rules comprises: comparing the plurality of frames of vehicle trajectory data to a corresponding plurality of frames output by a reference model; and outputting the alert when a specified number of consecutive frames of the vehicle trajectory data differ, by at least a threshold amount, from the corresponding plurality of frames output by the reference model.

A3. The cloud-based vehicle data processing system of solution A1, wherein the instructions when executed further cause the one or more processors to: generate a dashboard for display on the communications interface, the dashboard including a visual reconstruction of at least a portion of a trip by the first vehicle based on the plurality of measurements generated by the one or more sensors during the portion of the trip.

A4. The cloud-based vehicle data processing system of solution A3, wherein outputting the alert comprises outputting a notification via the communications interface for display on the dashboard during the visual reconstruction of the portion of the trip.

A5. The cloud-based vehicle data processing system of solution A4, wherein the notification identifies at least one of: an action performed by a driver of the first vehicle; an event detected in an environment of the first vehicle; or an action autonomously taken by the first vehicle.

A6. The cloud-based vehicle data processing system of solution A3, wherein generating the dashboard comprises outputting time-synchronized measurements that were generated by two or more sensors during the portion of the trip.

A7. The cloud-based vehicle data processing system of solution A1, wherein at least one alerting rule in the set of alerting rules is defined based on an input received at the communications interface of the cloud-based vehicle data processing system.

A8. A non-transitory computer readable storage medium storing executable instructions, execution of which by one or more processors causes the one or more processors to: receive, from each of a plurality of vehicles, a set of logged data captured during operation of a corresponding vehicle by a data logger communicatively coupled to a controller area network (CAN) bus in the corresponding vehicle, the set of logged data including a plurality of measurements generated by a sensor configured to transmit the plurality of measurements across the CAN bus, wherein the set of logged data is received from a storage device to which the set of logged data was uploaded after the corresponding vehicle completed one or more trips; perform, based on sets of logged data from the plurality of vehicles, at least a cross-sectional analysis or a longitudinal analysis for a subset of vehicles of the plurality of vehicles, wherein each of the subset of vehicles is of a common type; automatically generate, based on the cross-sectional analysis or the longitudinal analysis, a post-trip report to summarize operation of the corresponding vehicle during the one or more trips compared to at least another vehicle; and transmit, to the corresponding vehicle, the post-trip report.

A9. The non-transitory computer readable storage medium of solution A8, wherein the corresponding vehicle operated autonomously during at least a portion of the one or more trips, and wherein the plurality of measurements include vehicle trajectory measurements during portions of autonomous operation.

A10. The non-transitory computer readable storage medium of solution A8, wherein generating the post-trip report comprises: processing the set of logged data to perform a comparison operation of the corresponding vehicle during a first trip to operation of the corresponding vehicle during a second trip, wherein the post-trip report is generated to include the comparison operation.

A11. The non-transitory computer readable storage medium of solution A8, wherein generating the post-trip report comprises: processing the set of logged data to perform a comparison operation of the corresponding vehicle during a first trip to operation of a second vehicle during a second trip, wherein the post-trip report is generated to include the comparison operation.

A12. The non-transitory computer readable storage medium of solution A8, wherein the post-trip report includes indicators of one or more events detected during the one or more trips and selectable links associated with each of the one or more events, and wherein the executable instructions when executed further cause the one or more processors to: in response to selection by a user of one of the selectable links, generate a dashboard for display to the user, the dashboard including a visual reconstruction of a portion of a trip by the corresponding vehicle that includes the event corresponding to the selected link, the visual reconstruction based on the plurality of measurements generated by the sensor during the portion of the trip.

A13. The non-transitory computer readable storage medium of solution A8, wherein the post-trip report is generated to include a summary of an operational parameter specified by a user.

A14. The non-transitory computer readable storage medium of solution A8, wherein generating the post-trip report comprises producing a data file that is readable by a spreadsheet application.

A15. The non-transitory computer readable storage medium of solution A8, wherein execution of the executable instructions further causes the one or more processors to: process the set of logged data using an alerting rule that specifies a criterion, wherein generating the post-trip report comprises outputting an alert via the post-trip report when the criterion specified in the alerting rule is satisfied by the set of logged data.

A16. A method for detecting minimum risk condition (MRC) trajectory faults in an autonomous vehicle, the method comprising: receiving, by a vehicle data processing system from a controller area network (CAN) bus in each of a plurality of autonomous vehicles, a set of logged data that was captured during operation of a corresponding autonomous vehicle, the set of logged data including a plurality of frames of vehicle trajectory data of the corresponding autonomous vehicle that are measured by one or more sensors in the corresponding autonomous vehicle; identifying, by the vehicle data processing system, based on the plurality of frames of vehicle trajectory data, one or more frames in which the corresponding autonomous vehicle operated in an MRC mode; and generate, by the vehicle data processing system, an alert when the corresponding autonomous vehicle is determined to have operated in the MRC mode in at least a specified number of consecutive frames of the vehicle trajectory data.

A17. The method of solution A16, further comprising: outputting the alert in a data file that summarizes, for one or more trips of the corresponding autonomous vehicle, a count of events in which the corresponding autonomous vehicle operated in the MRC mode.

A18. The method of solution A16, further comprising: outputting the alert as an electronic message.

A19. The method of solution A16, further comprising: generating, by the vehicle data processing system, a dashboard populated with sensor data produced by at least one sensor in the corresponding autonomous vehicle; and outputting the alert via the dashboard.

A20. The method of solution A16, further comprising: producing a data file that is readable by a spreadsheet application.

The described embodiments further provide the following technical solutions:

B1. A vehicle data processing system, comprising: a communications interface; one or more processors coupled to the communications interface; and a non-transitory computer readable storage medium storing instructions, execution of which by the one or more processors causes the one or more processors to: receive a set of data logged during operation of a vehicle by a data logger communicatively coupled to a controller area network (CAN) bus in the vehicle, the set of logged data including a plurality of measurements generated by one or more sensors, wherein the one or more sensors are configured to transmit the plurality of measurements across the CAN bus, and wherein the set of logged data is received from a storage device to which the set of logged data was uploaded after the vehicle completed one or more trips; process the set of logged data using a set of alerting rules; and output an alert using the communications interface when a criterion in the set of alerting rules is satisfied by the set of logged data.

B2. The vehicle data processing system of solution B1, wherein the set of logged data includes a plurality of frames of vehicle trajectory data of the vehicle, and wherein processing the set of logged data using the set of alerting rules comprises: comparing the plurality of frames of vehicle trajectory data to a corresponding plurality of frames output by a reference model; and outputting the alert when a specified number of consecutive frames of the vehicle trajectory data differ, by at least a threshold amount, from the corresponding plurality of frames output by the reference model.

B3. The vehicle data processing system of solution B1, wherein the instructions when executed further cause the one or more processors to: generate a dashboard for display on the communications interface, the dashboard including a visual reconstruction of at least a portion of a trip by the vehicle based on the measurements generated by the sensor during the corresponding portion of the trip.

B4. The vehicle data processing system of solution B3, wherein outputting the alert comprises outputting a notification via the communications interface for display on the dashboard during the visual reconstruction of the portion of the trip.

B5. The vehicle data processing system of solution B4, wherein the notification identifies at least one of: an action performed by a driver of the vehicle; an event detected in an environment of the vehicle; or an action autonomously taken by the vehicle.

B6. The vehicle data processing system of solution B3, wherein generating the dashboard comprises outputting time-synchronized measurements that were generated by two or more sensors during the corresponding portion of the trip.

B7. The vehicle data processing system of solution B1, wherein at least one alerting rule in the set of alerting rules is defined based on an input received at the communications interface of the vehicle data processing system.

B8. A non-transitory computer readable storage medium storing executable instructions, execution of which by one or more processors causes the one or more processors to: receive a set of data logged during operation of a vehicle by a data logger communicatively coupled to a controller area network (CAN) bus in the vehicle, the set of logged data including a plurality of measurements generated by a sensor configured to transmit the plurality of measurements across the CAN bus, wherein the set of logged data is received from a storage device to which the set of logged data was uploaded after the vehicle completed one or more trips; automatically generate a post-trip report to summarize operation of the vehicle during the one or more trips based on the set of logged data; and output the post-trip report.

B9. The non-transitory computer readable storage medium of solution B8, wherein the vehicle operated autonomously during at least a portion of the one or more trips, and wherein the plurality of measurements include vehicle trajectory measurements during portions of autonomous operation.

B10. The non-transitory computer readable storage medium of solution B8, wherein generating the post-trip report comprises: processing the set of logged data to compare operation of the vehicle during a first trip to operation of the vehicle during a second trip; wherein the post-trip report is generated to include the comparison.

B11. The non-transitory computer readable storage medium of solution B8, wherein generating the post-trip report comprises: processing the set of logged data to compare operation of the vehicle during a first trip to operation of a second vehicle during a second trip; wherein the post-trip report is generated to include the comparison.

B12. The non-transitory computer readable storage medium of solution B8, wherein the post-trip report includes indicators of one or more events detected during the one or more trips and a selectable link associated with each of the one or more events, and wherein the instructions when executed further cause the one or more processors to: in response to selection by a user of one of the selectable links, generate a dashboard for display to the user, the dashboard including a visual reconstruction of a portion of a trip by the vehicle that includes the event corresponding to the selected link, the visual reconstruction based on the measurements generated by the sensor during the corresponding portion of the trip.

B13. The non-transitory computer readable storage medium of solution B8, wherein the post-trip report is generated to include a summary of an operational parameter specified by a user.

B14. The non-transitory computer readable storage medium of solution B8, wherein generating the post-trip report comprises producing a data file that is readable by a spreadsheet application.

B15. The non-transitory computer readable storage medium of solution B8, wherein execution of the instructions further causes the one or more processors to: process the set of logged data using an alerting rule that specifies a criterion, wherein generating the post-trip report comprises outputting an alert via the post-trip report when the criterion specified in the alerting rule is satisfied by the set of logged data.

B16. A method for detecting minimum risk condition (MRC) trajectory faults in an autonomous vehicle, the method comprising: receiving, at a vehicle data processing system, a set of data logged from a controller area network (CAN) bus in the autonomous vehicle during operation of the autonomous vehicle, the set of logged data including a plurality of frames of vehicle trajectory data of the autonomous vehicle that are measured by one or more sensors in the autonomous vehicle; identifying, by the vehicle data processing system, based on the plurality of frames of vehicle trajectory data, one or more frames in which the autonomous vehicle operated in an MRC mode; and generating, by the vehicle data processing system, an alert when the autonomous vehicle is determined to have operated in the MRC mode in at least a specified number of consecutive frames of the vehicle trajectory data.

B17. The method of solution B16, further comprising: outputting the alert in a data file that summarizes, for one or more trips of the vehicle, a count of events in which the autonomous vehicle operated in the MRC mode.

B18. The method of solution B16, further comprising: outputting the alert as an electronic message.

B19. The method of solution B16, further comprising: generating, by the vehicle data processing system, a dashboard populated with sensor data produced by at least one sensor in the autonomous vehicle; and outputting the alert via the dashboard.

B20. The method of solution B16, further comprising: producing a data file that is readable by a spreadsheet application.

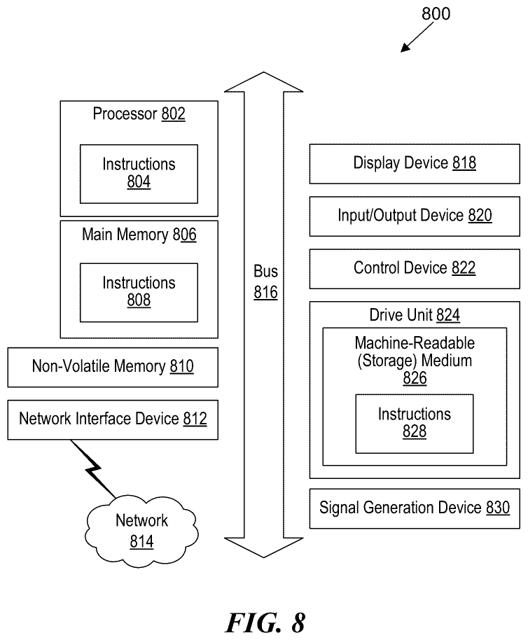

FIG. 8 is a block diagram that illustrates an example of a computer system 800 in which at least some operations described herein can be implemented. As shown, the computer system 800 can include: one or more processors 802, main memory 806, non-volatile memory 810, a network interface device 812, video display device 818, an input/output device 820, a control device 822 (e.g., keyboard and pointing device), a drive unit 824 that includes a storage medium 826, and a signal generation device 830 that are communicatively connected to a bus 816. The bus 816 represents one or more physical buses and/or point-to-point connections that are connected by appropriate bridges, adapters, or controllers. Various common components (e.g., cache memory) are omitted from FIG. 8 for brevity. Instead, the computer system 800 is intended to illustrate a hardware device on which components illustrated or described relative to the examples of the figures and any other components described in this specification can be implemented.

The computer system 800 can take any suitable physical form. For example, the computing system 800 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 800. In some implementation, the computer system 800 can be an embedded computer system, a system-on-chip (SOC), a single-board computer system (SBC) or a distributed system such as a mesh of computer systems or include one or more cloud components in one or more networks. Where appropriate, one or more computer systems 800 can perform operations in real-time, near real-time, or in batch mode.

The network interface device 812 enables the computing system 800 to mediate data in a network 814 with an entity that is external to the computing system 800 through any communication protocol supported by the computing system 800 and the external entity. Examples of the network interface device 812 include a network adaptor card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 806, non-volatile memory 810, machine-readable medium 826) can be local, remote, or distributed. Although shown as a single medium, the machine-readable medium 826 can include multiple media (e.g., a centralized/distributed database and/or associated caches and servers) that store one or more sets of instructions 828. The machine-readable (storage) medium 826 can include any medium that is capable of storing, encoding, or carrying a set of instructions for execution by the computing system 800. The machine-readable medium 826 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 810, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 804, 808, 828) set at various times in various memory and storage devices in computing device(s). When read and executed by the processor 802, the instruction(s) cause the computing system 800 to perform operations to execute elements involving the various aspects of the disclosure.

The terms “example”, “embodiment” and “implementation” are used interchangeably. For example, reference to “one example” or “an example” in the disclosure can be, but not necessarily are, references to the same implementation; and, such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described which can be exhibited by some examples and not by others. Similarly, various requirements are described which can be requirements for some examples but no other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples, but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a mean-plus-function claim will use the words “means for.” However, the use of the term “for” in any other context is not intended to invoke a similar interpretation. The applicant reserves the right to pursue such additional claim forms in either this application or in a continuing application.

What is claimed is:

1. A cloud-based vehicle data processing system, comprising:
a communications interface coupled to each of a plurality of vehicles;
one or more processors coupled to the communications interface; and
a non-transitory computer readable storage medium storing instructions, execution of which by the one or more processors causes the one or more processors to:
receive, from each of the plurality of vehicles, a set of logged data captured during operation of a corresponding vehicle by a data logger communicatively coupled to a controller area network (CAN) bus in the corresponding vehicle, wherein each set of logged data includes a plurality of measurements generated by one or more sensors, wherein the one or more sensors are configured to transmit the plurality of measurements across the CAN bus, and wherein each set of logged data is received from a storage device to which the set of logged data was uploaded after the corresponding vehicle completed one or more trips;
filter, based on a type of vehicle, sets of logged data to generate filtered sets of logged data;
process the filtered sets of logged data using a set of alerting rules configured based on the type of vehicle; and
transmit, to a first vehicle using the communications interface, an alert when a criterion in the set of alerting rules is satisfied by the set of logged data from the first vehicle.

2. The cloud-based vehicle data processing system of claim 1, wherein the set of logged data includes a plurality of frames of vehicle trajectory data of the first vehicle, and wherein processing the set of logged data using the set of alerting rules comprises:
comparing the plurality of frames of vehicle trajectory data to a corresponding plurality of frames output by a reference model; and
outputting the alert when a specified number of consecutive frames of the vehicle trajectory data differ, by at least a threshold amount, from the corresponding plurality of frames output by the reference model.

3. The cloud-based vehicle data processing system of claim 1, wherein the instructions when executed further cause the one or more processors to:
generate a dashboard for display on the communications interface, the dashboard including a visual reconstruction of at least a portion of a trip by the first vehicle based on the plurality of measurements generated by the one or more sensors during the portion of the trip.

4. The cloud-based vehicle data processing system of claim 3, wherein outputting the alert comprises outputting a notification via the communications interface for display on the dashboard during the visual reconstruction of the portion of the trip.

5. The cloud-based vehicle data processing system of claim 4, wherein the notification identifies at least one of:
an action performed by a driver of the first vehicle;
an event detected in an environment of the first vehicle; or
an action autonomously taken by the first vehicle.

6. The cloud-based vehicle data processing system of claim 3, wherein generating the dashboard comprises outputting time-synchronized measurements that were generated by two or more sensors during the portion of the trip.

7. The cloud-based vehicle data processing system of claim 1, wherein at least one alerting rule in the set of alerting rules is defined based on an input received at the communications interface of the cloud-based vehicle data processing system.

8. A non-transitory computer readable storage medium storing executable instructions, execution of which by one or more processors causes the one or more processors to:
receive, from each of a plurality of vehicles, a set of logged data captured during operation of a corresponding vehicle by a data logger communicatively coupled to a controller area network (CAN) bus in the corresponding vehicle, the set of logged data including a plurality of measurements generated by a sensor configured to transmit the plurality of measurements across the CAN bus, wherein the set of logged data is received from a storage device to which the set of logged data was uploaded after the corresponding vehicle completed one or more trips;
perform, based on sets of logged data from the plurality of vehicles, at least a cross-sectional analysis or a longitudinal analysis for a subset of vehicles of the plurality of vehicles, wherein each of the subset of vehicles is of a common type;
automatically generate, based on the cross-sectional analysis or the longitudinal analysis, a post-trip report to summarize operation of the corresponding vehicle during the one or more trips compared to at least another vehicle; and
transmit, to the corresponding vehicle, the post-trip report.

9. The non-transitory computer readable storage medium of claim 8, wherein the corresponding vehicle operated autonomously during at least a portion of the one or more trips, and wherein the plurality of measurements include vehicle trajectory measurements during portions of autonomous operation.

10. The non-transitory computer readable storage medium of claim 8, wherein generating the post-trip report comprises:
processing the set of logged data to perform a comparison operation of the corresponding vehicle during a first trip to operation of the corresponding vehicle during a second trip;
wherein the post-trip report is generated to include the comparison operation.

11. The non-transitory computer readable storage medium of claim 8, wherein generating the post-trip report comprises:
processing the set of logged data to perform a comparison operation of the corresponding vehicle during a first trip to operation of a second vehicle during a second trip;
wherein the post-trip report is generated to include the comparison operation.

12. The non-transitory computer readable storage medium of claim 8, wherein the post-trip report includes indicators of one or more events detected during the one or more trips and selectable links associated with each of the one or more events, and wherein the executable instructions when executed further cause the one or more processors to:
in response to selection by a user of one of the selectable links, generate a dashboard for display to the user, the dashboard including a visual reconstruction of a portion of a trip by the corresponding vehicle that includes the event corresponding to the selected link, the visual reconstruction based on the plurality of measurements generated by the sensor during the portion of the trip.

13. The non-transitory computer readable storage medium of claim 8, wherein the post-trip report is generated to include a summary of an operational parameter specified by a user.

14. The non-transitory computer readable storage medium of claim 8, wherein generating the post-trip report comprises producing a data file that is readable by a spreadsheet application.

15. The non-transitory computer readable storage medium of claim 8, wherein execution of the executable instructions further causes the one or more processors to:
process the set of logged data using an alerting rule that specifies a criterion;
wherein generating the post-trip report comprises outputting an alert via the post-trip report when the criterion specified in the alerting rule is satisfied by the set of logged data.

16. A method for detecting minimum risk condition (MRC) trajectory faults in an autonomous vehicle, the method comprising:
receiving, by a vehicle data processing system from a controller area network (CAN) bus in each of a plurality of autonomous vehicles, a set of logged data that was captured during operation of a corresponding autonomous vehicle, the set of logged data including a plurality of frames of vehicle trajectory data of the corresponding autonomous vehicle that are measured by one or more sensors in the corresponding autonomous vehicle;
identifying, by the vehicle data processing system, based on the plurality of frames of vehicle trajectory data, one or more frames in which the corresponding autonomous vehicle operated in an MRC mode; and
generate, by the vehicle data processing system, an alert when the corresponding autonomous vehicle is determined to have operated in the MRC mode in at least a specified number of consecutive frames of the vehicle trajectory data.

17. The method of claim 16, further comprising:
outputting the alert in a data file that summarizes, for one or more trips of the corresponding autonomous vehicle, a count of events in which the corresponding autonomous vehicle operated in the MRC mode.

18. The method of claim 16, further comprising:
outputting the alert as an electronic message.

19. The method of claim 16, further comprising:
generating, by the vehicle data processing system, a dashboard populated with sensor data produced by at least one sensor in the corresponding autonomous vehicle; and
outputting the alert via the dashboard.

20. The method of claim 16, further comprising:
producing a data file that is readable by a spreadsheet application.
